(19) United States
(12) Patent Application Publication
(10) Pub. No.: US 2008/0038483 A1
(43) Pub. Date: Feb. 14, 2008

(54) Adhesion of hydrophobic coatings on eyeglass lenses

(75) Inventors: Baerbel Goetz, Augsburg (DE); Cecile Stolz, Muenchen (DE); Gerd-Peter Scherg, Baldham (DE); Silvia Tomalka, Unterhaching (DE)

Correspondence Address: CROWELL & MORING LLP;INTELLECTUAL PROPERTY GROUP, P.O. BOX 14300, WASHINGTON, DC, 20044-4300, US

(73) Assignee: Rodenstock GmbH, Muenchen (DE)

(21) Appl. No.: 11/753,729

(22) Filed: May 25, 2007

Related U.S. Application Data
(63) Continuation of application No. PCT/EP05/11040, filed on Oct. 13, 2005.

(30) Foreign Application Priority Data
Nov. 25, 2004 (DE) 10 2004 056 965.7

(51) Int. Cl. H05H 1/24

(52) U.S. Cl. 427/576; 427/577

(57) ABSTRACT

A method for producing an eyeglass lens provided with improved adhesion between an antireflective coating or mirror coating that is applied to the eyeglass lens. The lens may have a single-layer or multilayer structure and a hydrophobic and/or oleophobic coating. The method includes the steps of: providing an eyeglass lens; optionally applying a hard layer to the surface of the eyeglass lens; applying an antireflective coating or mirror coating encompassing one or several antireflective layers or mirror layers; performing a plasma treatment after applying the outermost antireflective layer; and applying a hydrophobic and/or oleophobic coating.

### CROSS REFERENCE TO RELATED APPLICATIONS

This application is a continuation of International patent application Serial No. PCT/EP2005/011040, filed Oct. 13, 2005, designating the United States of America and published in German as WO 2006/056274 A1, the entire disclosure of which is incorporated herein by reference. Priority is claimed based on Federal Republic of Germany patent application no. DE 10 2004 056 965.7, filed Nov. 25, 2004.

### FIELD OF THE INVENTION

The present invention relates to a method for producing an ophthalmic lens having improved adhesion between an antireflective or mirrorized coating which has a single-layer or multilayer structure and is applied to the lens, and a hydrophobic and/or oleophobic coating.

### BACKGROUND OF THE INVENTION

Ophthalmic lenses having an antireflective coating and a hydrophobic coating applied thereto are known in the state of the art. However, such layered systems have the problem that the lifetime of a hydrophobic coating is often inadequate because the adhesion between the antireflective coating and the hydrophobic coating is inadequate.

### SUMMARY OF THE INVENTION

Thus, the technical object of the present invention is to provide a method for manufacturing an ophthalmic lens having improved adhesion between an antireflective and/or mirrorized coating applied to the lens and the hydrophobic and/or oleophobic coating (also known as a top coat).

This object is achieved by providing the embodiments characterized in the claims.

In particular, a method is made available according to the present invention for manufacturing an ophthalmic lens having improved adhesion between an antireflective or mirrorized coating that has a single-layer or multilayer structure and is applied to the lens, and a hydrophobic and/or oleophobic coating, comprising the steps:

(a) providing an (uncoated) ophthalmic lens,

(b) optionally applying a hard layer to the surface of the lens,

(c) applying an antireflective or mirrorized coating comprising one or more antireflective or mirrorized layers,

(d) performing a plasma treatment after applying the last and/or outermost antireflective layer and

(e) applying a hydrophobic and/or oleophobic coating.

The ophthalmic lens may be a synthetic lens, e.g., made of polythiourethane, polyepisulfide, PMMA, polycarbonate, polyacrylate or polydiethylene glycol bisallyl carbonate (CR 39®) or any mixtures of two or more of such materials, or a mineral lens may be used.

The hard layer optionally applied in the inventive method is not subject to any particular restrictions. A hard layer may have a single-layer or multilayer structure. Various materials and methods may be used to produce the hard layer. Those skilled in the art will be capable of selecting suitable materials for the hard layer and the thickness of the hard layer in a suitable manner. The hard layer is generally applied in the form of a hard lacquer or an inorganic material, in particular based on quartz, by plasma-supported vapor deposition techniques or CVD methods. As a rule, a hard lacquer is applied by a conventional method such as an immersion method, a spray method or a spin coating method. However, it is preferable to use a hard layer based on an acrylic polymer, a urethane polymer, a melamine polymer, a silicone resin or an inorganic material, in particular based on quartz. According to a particularly preferred embodiment, a silicone resin is applied as the hard layer to the surface of the ophthalmic lens, e.g., starting from siloxanes.

Suitable silicone resins have a composition comprising one or more of the following components:

(1) Organosiloxane compounds with or without functional groups such as glycidoxypropyl trimethoxysilane,

(2) Co-reactants for functional groups of functional organosilanes such as organic epoxides, amines, organic acids, organic anhydrides, imides, amides, ketamines, acrylic compounds and isocyanates,

(3) Colloidal silicon dioxide, sols and/or metal and nonmetal oxide sols, preferably having an average partial diameter of approximately 1 nm to approximately 100 nm and especially preferably approximately 5 nm to approximately 40 nm,

(4) Catalysts for silanol condensation such as dibutyltin dilaurate, zinc naphthenate, aluminum acetylacetonate, zirconium octoate, lead 2-ethylhexoate, aluminum alkoxides and aluminum alkoxide organosilicon derivatives and titanium acetylacetonate.

(5) Catalysts for co-reactants such as epoxy catalysts and catalysts of the free radical type,

(6) Solvents such as water, alcohols and ketones,

(7) Surfactants such as fluorinated surfactants or surfactants of the polydimethylsiloxane type,

(8) Other additives such as fillers; such materials are described in EP 0 871 907 B1, for example, see paragraphs [0023] through [0026].

The layer thickness of the hard layer is basically not subject to any particular restriction. However, it is preferably set at a thickness of ≦10 μm, more preferably 1 to 6 μm, especially preferably 2 to 3 μm.

The antireflective coating may have a single-layer or multilayer structure. Those skilled in the art are familiar with such single-layer or multilayer antireflective coatings and will be capable of selecting suitable materials and layer thicknesses of an antireflective coating and/or the individual antireflective layers in a suitable manner. An antireflective coating having a single-layer, two-layer, three-layer, four-layer, five-layer or six-layer structure is preferably chosen. For antireflective coatings having a two-layer or multilayer structure, a layer sequence in which an antireflective layer with a high refractive index is adjacent to an antireflective layer having a low refractive index will be selected. In other words, it is preferable for such a multilayer structure if antireflective layers having a low refractive index alternate with antireflective layers having a high refractive index. In addition, other layers, e.g., adhesive layers (e.g., with a thickness of approx. nm) that need not have any optical function but are advantageous for the stability, adhesive properties, climate resistance, etc., may also be incorporated. For example, it is also possible to replace the aforementioned antireflective coating by a mirrorized coating comprising one or more mirrorized layers and optionally antireflective layers.

Examples of suitable materials for the antireflective and/or mirrorized coating include metals, nonmetals such as silicon or boron, oxides, fluorides, silicides, borides, carbides, nitrides and sulfides of metals and the aforementioned nonmetals. These substances may be used individually or as a mixture of two or more of these materials.

Preferred metals oxides and/or nonmetal oxides include SiO, SiO₂, ZrO₂, Al₂O₃, TiO, TiO₂, Ti₂O₃, Ti₃O₄, CrOx (where x=1-3), Cr₂O₃, Y₂O₃, Yb203, MgO, Ta₂O₅, CeO₂ and HfO₂.

Preferred fluorides include MgF₂, AlF₃, BaF₂, CaF₂, Na₃AlF₆ and Na₅Al₃F₁₄.

Preferred metals include for example Cr, W, Ta and Ag.

It is especially preferable to use SiO₂ as the material for the last, i.e., outermost antireflective layer (as seen starting from the surface of the lens), i.e., the antireflective layer that is in contact with the hydrophobic and/or oleophobic coating.

The antireflective coating described above may be applied by conventional methods, but it is preferable to apply the individual antireflective layers by vacuum deposition or by sputtering.

The layer thickness of the antireflective coating having a single-layer or multilayer design is basically not subject to any restrictions. However, it is preferably adjusted to a thickness of ≦400 nm, preferably ≦300 nm, especially preferably ≦250 nm. However, the minimum layer thickness of the antireflective coating is preferably approximately ≧100 nm. In the case of a multilayer design of the antireflective coating, the thickness of each individual layer (i.e., antireflective layer) is adjusted in a suitable way as described above.

For example, such an antireflective coating may be composed of alternating high-refraction and low-refraction layers of TiO₂ and/or SiO₂, e.g., with λ/8-TiO₂, λ/8-SiO₂, λ/2-TiO₂ and λ/4-SiO₂, where λ stands for light with a wavelength of 550 nm. Such an antireflective coating with a multilayer structure can be produced by known PVD methods, for example.

Those skilled in the art know of suitable hydrophobic and/or oleophobic coatings, which are not subject to any particular restrictions as long as the result is a coating that has hydrophobic and/or oleophobic properties and adequate adhesion properties, e.g., materials based on silane. The hydrophobic and/or oleophobic coating preferably comprises a silane having at least one group containing fluorine, preferably having more than 20 carbon atoms. However, it may also be composed of a corresponding siloxane or silazane, preferably including at least one group containing fluorine. The silane with at least one group containing fluorine is preferably based on a silane with at least one hydrolyzable group. Suitable hydrolyzable groups are not subject to any particular restrictions and those skilled in the art will know of examples thereof. Examples of hydrolyzable groups bound to a silicon atom include halogen atoms such as chlorine, N-alkyl groups such as —N(CH₃)₂ or —N(C₂H₅)₂, alkoxy groups or isocyanate groups, whereby an alkoxy group, in particular a methoxy group or an ethoxy group, is preferred as the hydrolyzable group. However, it is also possible to use a silane having at least one group containing fluorine and having at least hydroxyl group.

The silane having at least one group containing fluorine preferably comprises one or more polyfluorinated groups or one or more perfluorinated groups, whereby one or more polyfluorinated or perfluorinated alkyl groups, one or more polyfluorinated or perfluorinated alkenyl groups and/or one or more polyfluorinated or perfluorinated groups containing polyether units are especially preferred. Preferred groups containing polyether units include one or more —(CF₂)ₓO units where x=1 to 10, but x=2 to 3 is especially preferred.

According to a preferred embodiment of the present invention, the silane has a group containing fluorine and three hydrolyzable groups or hydroxyl groups.

Furthermore, it may be preferable for the hydrophobic and/or oleophobic coating to be composed of a polyfluorinated or perfluorinated hydrocarbon compound. The polyfluorinated or perfluorinated hydrocarbon compound is not subject to any particular restrictions, but it is preferable to use polytetrafluoroethylene as the polyfluorinated or perfluorinated hydrocarbon compound.

The hydrophobic and/or oleophobic coating is preferably exclusively composed of a silane having at least one group containing fluorine or a polyfluorinated or perfluorinated hydrocarbon compound. However, it is also possible to use a mixture of one or more of these silanes and/or one or more polyfluorinated or perfluorinated hydrocarbon compounds, optionally with other inorganic, organic, organometallic additives for the hydrophobic and/or oleophobic coating.

The hydrophobic and/or oleophobic coating may be applied by conventional methods, but it is preferable to apply this coating by vapor deposition, a CVD method or an immersion method.

The layer thickness of the hydrophobic and/or oleophobic coating is essentially not subject to any particular restriction, but it is preferably set at a thickness of ≦50 nm, more preferably ≦20 nm.

The plasma treatment is performed after applying the one and/or the last antireflective layer, if the antireflective coating has a multilayer structure, and before applying a hydrophobic and/or oleophobic coating. The term plasma treatment is understood according to the present invention to refer to a method in which the surface of the lens is brought in contact with a plasma and ions of the plasma chemically and/or physically alter the surface such that the adhesion of the hydrophobic and/or oleophobic coating to be applied thereafter is significantly improved.

The plasma coating may be performed in particular (a) in a separate installation before an immersion coating, for example, (b) as a first step in the application of the top coat if the top coat is applied in a separate installation, (c) as the last step of the antireflective coating if the top coat is applied in a separate installation or (d) as the last process step before applying the top coat if the antireflective coating and the top coat(s) are applied in one installation.

The process gases suitable for the plasma treatment are not subject to any particular restrictions, but it is preferable to use argon, oxygen, nitrogen, CF₄ and/or a mixture of two or more of the aforementioned substances. Argon in particular is used as the process gas in the plasma treatment step. It is especially advantageous to use a mixture of argon and oxygen in the plasma treatment step, whereby the ratio of argon to oxygen is in a range of 3:1 to 1:3, based on volume.

The ionic energy in the plasma treatment step is preferably set in a range of approximately 1 eV to approximately 1000 eV, especially preferably 5 eV to 500 eV, most preferably 50 eV to 100 eV.

The ionic current density in the plasma treatment step is preferably in a range of 10¹⁴ to 10¹⁹ ions/(cm²s), especially preferably from 10¹⁵ to 10¹⁸ ions/(cm²s), whereby an ionic current density of approximately 10¹⁷ ions/(cm²s) is most preferred.

The duration of the plasma treatment step is not subject to any particular restrictions, but it is preferable to perform the plasma treatment for ten seconds to ten minutes, especially preferably 30 seconds to two minutes, typically one minute to two minutes.

With the inventive method, it is possible to manufacture an ophthalmic lens that has a definitely improved adhesion between the antireflective coating and the hydrophobic and/or oleophobic coating. Because of this substantial improvement in adhesion, the lifetime and/or service life of the hydrophobic and/or oleophobic coating used is significantly increased.

The following test which simulates daily cleaning of ophthalmic lenses over a long period of time is used as the test of the lifetime and/or service life of a hydrophobic and/or oleophobic coating:

A lens is clamped in the service life test and stressed with at least 1000 strokes with a conventional commercial cotton cloth or microfiber cloth with an applied force of approximately 10 N on a contact surface with a radius of 1 cm. The reduction in surface energy is tested as a measure of wear (according to the Owens-Wendt method as described in “Estimation of the surface force energy of polymers,” Owens, D. K., Wendt, R. G. (1969), J. Appl. Polym. Sci., 13, 1741-1747; the liquids used in the Owens-Wendt method include water, diiodomethane and hexadecane).

Ophthalmic lenses manufactured by the method described in the state of the art frequently fail after only 1000 strokes, which corresponds to a service life in practice of approximately ½ year. Ophthalmic lenses manufactured by the inventive method have a significantly improved service life. As a rule, ophthalmic lenses manufactured by the inventive method do not fail until after approximately 4000 to 6000 strokes, which corresponds to prolonging the lifetime by a factor of approximately 4 to 6.

Certain embodiments of the present invention may be further understood by reference to the following specific example. This example and the terminology used herein are for the purpose of describing particular embodiments only and are not intended to be limiting.

### EXAMPLE

The antireflective coating and the hydrophobic and/or oleophobic coating were applied to an ophthalmic lens in an installation of the type APS 904. A Solitaire coating method was performed with plasma treatment after application of the last SiO₂ antireflective layer with the following parameters:

(a) Gases: Ar, O₂, N₂ or CF₄ or mixtures thereof;

(b) Gas flow (sccm; standard cubic centimeter): 6, 8, 10, 12, 15, 20, 25 or 30;

(c) Blow voltage (V): 40, 60, 80, 100, 120 or 150;

(d) Discharge current (A): 10, 20, 30, 40 or 50;

(e) Time (s): 30, 60 120 or 300.

The foregoing description and example have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A method for manufacturing an ophthalmic lens with an antireflective or mirrorized coating and a hydrophobic or oleophobic coating or both a hydrophobic and an oleophobic coating, comprising the steps of:
(a) providing an ophthalmic lens,
(b) optionally applying a hard layer to the surface of the ophthalmic lens,
(c) applying an antireflective or mirrorized coating comprising one or more antireflective or mirrorized layers,
(d) performing a plasma treatment after applying the outermost antireflective layer, and
(e) applying a hydrophobic or oleophobic coating or a hydrophobic and an oleophobic coating.

2. The method of claim 1, wherein the ophthalmic lens is a plastic lens or a mineral lens.

3. The method of claim 1, wherein the hard layer is based on an acrylic polymer, a urethane polymer, a melamine polymer, a silicone resin or an inorganic material.

4. The method of claim 3, where the hard layer is based on quartz.

5. The method of claim 1, wherein the antireflective or mirrorized coating includes metals, nonmetals such as silicon or boron, oxides, fluorides, silicides, borides, carbides, nitrides or sulfides of metals and the aforementioned nonmetals.

6. The method of claim 1, wherein the hydrophobic or oleophobic coating comprises a silane having at least one group containing fluorine or a polyfluorinated or perfluorinated hydrocarbon compound or a combination of a fluorine and a polyfluorinated or perfluorinated hydrocarbon compound.

7. The method of claim 1, wherein the process gas of the plasma treatment step is selected from the group comprising argon, oxygen, nitrogen and CF₄ or a mixture of two or more thereof.

8. The method of claim 1, wherein the ionic energy in the plasma treatment step is adjusted in a range of from 1 eV to 1000 eV.

9. The method of claim 1, wherein the ionic current density in the plasma treatment step is adjusted in a range of from 10¹⁴ to 10¹⁹ ions/(cm²s).
